(19) United States
(12) Patent Application Publication
(10) Pub. No.: US 2013/0229408 A1
(43) Pub. Date: Sep. 5, 2013

(54) APPARATUS AND METHOD FOR EFFICIENT VIEWER-CENTRIC DEPTH ADJUSTMENT BASED ON VIRTUAL FRONTO-PARALLEL PLANAR PROJECTION IN STEREOSCOPIC IMAGES

(71) Applicants: Sang Hoon Sull, Seoul (KR); Han Je Park, Gyeonggi-Do (KR); Hoon Jae Lee, Gyeonggi-Do (KR)

(72) Inventors: Sang Hoon Sull, Seoul (KR); Han Je Park, Gyeonggi-Do (KR); Hoon Jae Lee, Gyeonggi-Do (KR)

(73) Assignee: Korea University Research and Business Foundation, Seoul (KR)

(21) Appl. No.: 13/605,575

(22) Filed: Sep. 6, 2012

(30) Foreign Application Priority Data
Mar. 5, 2012 (KR) 10-2012-0022498
Sep. 6, 2012 (KR) 10-2012-0099018

(51) Int. Cl. G06T 15/00

(52) U.S. Cl. 345/419

(57) ABSTRACT

Provided is an image processing apparatus and method for adjusting a depth of stereoscopic images including a plane determining unit to determine a first predetermined plane parallel to a first image, a depth adjusting unit to determine a second point by projecting a first point of the first image onto the first plane in a direction of a first viewer's viewpoint associated with the first image, to determine a third point by moving the second point, according to a depth adjustment value, and to determine a fourth point by projecting the third point onto the first image in a direction from the first viewer's viewpoint to the third point, and an image synthesizing unit to generate a second image which represents the depth adjusted scene obtained from the first image by determining a color value of the fourth point.

### TECHNICAL FIELD

The present invention relates to an apparatus and method for adjusting a depth with respect to at least one view image, in stereoscopic images or multi-view images that implement a three-dimensional (3D) image.

### BACKGROUND ART

Following a growth of three-dimensional (3D) consumer electronics industry, research on a 3D television (TV) or display has recently gained a great deal of interest. In particular, in order to alleviate visual fatigue and/or improve 3D effects of a portion of objects, research on a method of adjusting depths in stereoscopic images is receiving attention since a depth of an object displayed on a 3D display may need to be adjusted.

Generally, in conventional methods for adjusting a depth of a predetermined object, 3D object information may be reconstructed based on a disparity field or a disparity map, and a depth of a partial object may be adjusted in a 3D space.

Here, methods of computing the disparity map include: RANdom Sample Consensus (RANSAC) introduced by Z. F. Wang [“A Region Based Stereo Matching Algorithm Using Cooperative Optimization,” In Proc. of IEEE International Conference on Computer Vision and Pattern Recognition, pp. 1-8, June 2008]; dynamic programming introduced by C. H. Shin, C. M. Cheng, S. H. Lai, and S. Y. Yang [“Geodesic treebased dynamic programming for fast stereo reconstruction,” In Proc, of IEEE International Conference on Computer Vision Workshops, pp, 801-807, September 2009]) graph cut introduced by Y. Boykov, O. Veksler, and R. Zabih [“Fast approximate energy minimization via graph cuts,” IEEE Transactions on Pattern Analysis and Machine Intelligence, vol. 23, no. 11, November 2001]; and layer division introduced by D. Chai, and Q. Peng [“Bilayer stereo matching,” In Proc, of International Conference on Computer Vision, pp. 1-8, October 2007].

In addition, several methods of computing the disparity field are described by M. Z. Brown, D. Burschka, and G. D. Hager [“Advances in computational stereo,” IEEE Transactions on Pattern Analysis and Machine Intelligence, vol. 25, no. 8, August 2003].

However, although intense computation is used, computing a disparity field from stereoscopic images has a limit in terms of accuracy. Accordingly, low quality of results may be obtained when a 3D depth is estimated and depth adjustment is performed using the disparity map.

Moreover, a complex interpolation may be needed to fill holes resulting from loss of color information occurring during a process of increasing a depth of an object, and results of the interpolation may be unsatisfactory.

One of the conventional methods of adjusting a depth of a predetermined object including the whole scene in stereoscopic images is the parallax adjustment method such that a disparity is adjusted to be uniform in an image region, by moving a region of the predetermined object image or the whole left image and the whole right image in a horizontal direction. However, in the parallax adjustment, the black vertical strips may be generated at each side of the left image and the right image, and distortion of a shape of object may occur. In addition, since a size of the whole image or the object felt by a viewer may remain the same despite the depth adjustment of the whole image or the object, a different 3D effect may be provided, when compared to a case of adjusting a depth in reality.

### DISCLOSURE

### Technical Solutions

According to an aspect of the present invention, there is provided an image processing apparatus including a depth adjusting unit to determine a second point by moving a first point of a first image constituting stereoscopic images in a viewer centric direction, according to a depth adjustment value, and to determine a third point by projecting the second point onto the first image in a direction from a first viewer's viewpoint associated with the first image to the second point, and an image synthesizing unit to generate a second image which represents the depth adjusted scene obtained from the first image by determining a color value of the third point.

A difference between a depth value of the first point and a depth value of the second point may be identical to the depth adjustment value.

The first point may correspond to a central point of at least one region of the first image, where the at least one region whose depth is set to be adjusted, and the depth adjusting unit may perform depth adjustment for all points included in the at least one region, based on the movement of the first point.

The depth adjusting unit may determine a scaling factor and a translation factor for moving the first point to the third point, based on a position of the first image, a position of the first viewer's viewpoint, the viewer centric direction, and the depth adjustment value.

According to another aspect of the present invention, there is provided an image processing apparatus including a plane determining unit to determine a first predetermined plane parallel to a first image constituting stereoscopic images, a depth adjusting unit to determine a second point by projecting a first point of the first image onto the first plane in a direction of a first viewer's viewpoint associated with the first image, to determine a third point by moving the second point in a viewer centric direction, according to a depth adjustment value, and to determine a fourth point by projecting the third point onto the first image in a direction from the first viewer's viewpoint to the third point, and an image synthesizing unit to generate a second image which represents the depth adjusted scene obtained from the first image by determining a color value of the fourth point.

A difference between a depth value of the second point and a depth value of the third point on the first plane may be identical to the depth adjustment value.

The image synthesizing unit may determine the color value of the fourth point, based on color values of pixels adjacent to a pixel positioned in the first image at a position corresponding to the fourth point.

According to still another aspect of the present invention, there is provided an image processing apparatus including a depth adjusting unit to determine a second point by moving a first point of a first image constituting stereoscopic images according to a depth adjustment value in a normal direction which is perpendicular to the display screen, and to determine a third point by projecting the second point onto the display screen in a direction from a first viewer's viewpoint associated with the first image to the second point, and an image synthesizing unit to generate a second image which represents the depth adjusted scene obtained from the first image by determining a color value of the third point.

According to yet another aspect of the present invention, there is provided an image processing apparatus including an object extracting unit to extract an object region from a region of interest (ROI) that is selected from a first image constituting stereoscopic images, a planar approximation unit to determine a first plane representing a plurality of points, by performing planar approximation with respect to three-dimensional (3D) information about the plurality of points included in the object region, and a depth adjusting unit to determine a second plane by moving the first plane in a first direction in order to readjust a depth of the object region in the first image.

The object extracting unit may extract the object region, based on a portion of information from a disparity map associated with the first image, corresponding to the object region of the first image, and color information corresponding to the object region in color information of the first image.

The object extracting unit may remove noise, by performing pre-processing of at least one of erosion and dilation on the object region.

The planar approximation unit may determine the first plane, by applying the least squares method to the 3D information about the plurality of points.

The image processing apparatus may further include an image synthesizing unit to generate a second image which represents the depth adjusted scene obtained from the first image, by projecting the object region onto the first image based on the second plane.

The depth adjusting unit may select a first point in the first plane, determine a direction from the first point to a camera viewpoint associated with the first image to be the first direction, and determine the second plane by moving the first plane in the first direction.

The depth adjusting unit may select, to be the first point, a point that minimizes loss of color information of the first image, among the plurality of points included in the object region, when the first plane is moved in the first direction.

According to further another aspect of the present invention, there is provided an image processing apparatus including an object extracting unit to extract an object region from a first image constituting stereoscopic images, and a depth adjusting unit to calculate the changed position of the object region, by applying a scaling factor and a translation factor that are determined by changing the depth of the object region in the first image to each of a value of an X and Y coordinates corresponding to a horizontal direction and vertical direction of a plurality of points included in the object region, respectively.

The depth adjusting unit may determine a value by which the object region is moved in at least one direction of the X coordinate direction and the Y coordinate direction such that loss of color information of the first image is minimized, when the depth of the object region in the first image is adjusted by applying the scaling factor.

The image processing apparatus may further include art image synthesizing unit to generate a second image which represents the depth adjusted scene obtained from the first image, by reconstructing the object region in the first image using the changed position of the object region.

The image synthesizing unit may compare the second image to the first image, for each pixel, and utilize pixel values of the first image if a pixel in the first image corresponding to a first pixel included in the second image is included in the object region, in order to determine the values of pixels included in the second image.

The image synthesizing unit may determine a value of the first pixel through a bilinear interpolation using pixel values of adjacent pixels, when determining the value of the first pixel included in the second image by the comparison of each pixel fails.

According to still another aspect of the present invention, there is provided an image processing method including determining, by a depth adjusting unit of an image processing apparatus, a second point by moving a first point of a first image constituting stereoscopic images in a viewer centric direction, according to a depth adjustment value, determining, by the depth adjusting unit, a third point by projecting the second point onto the first image in a direction from a first viewer's viewpoint associated with the first image to the second point, and generating, by an image synthesizing unit of the image processing apparatus, a second image which represents the depth adjusted scene obtained from the first image by determining a color value of the third point.

According to still another aspect of the present invention, there is provided an image processing method including determining by a depth adjusting unit of an image processing apparatus, a scaling factor and a translation factor, based on a position of a first image constituting stereoscopic images, a position of a first viewer's viewpoint corresponding to the first image, a viewer centric direction, and a depth adjustment value, determining, by the depth adjusting unit, a second point whose depth is adjusted, by applying the scaling factor and the translation factor to position of a first point included in the first image and being a target for depth adjustment, and generating, by an image synthesizing unit of the image processing apparatus, a second image which represents the depth adjusted scene obtained from the first image by determining a color value of the second point.

According to still another aspect of the present invention, there is provided an image processing method including determining, by a plane determining unit of an image processing apparatus, a first predetermined plane parallel to a first image constituting stereoscopic images, determining a second point by projecting a first point of the first image onto the first plane in a direction of a first viewer's viewpoint associated with the first image, determining a third point by moving the second point in a viewer centric direction, according to a depth adjustment value, and determining a fourth point by projecting the third point onto the first image in a direction from the first viewer's viewpoint to the third point, by a depth adjusting unit of the image processing apparatus, and generating, by an image synthesizing unit of the image processing apparatus, a second image which represents the depth adjusted scene obtained from the first image by determining a color value of the fourth point.

According to still another aspect of the present invention, there is provided an image processing method including extracting, by an object extracting unit of an image processing apparatus, an object region from an ROI that is selected from a first image constituting stereoscopic images, determining, by a planar approximation unit of the image processing apparatus, a first plane representing a plurality of points, by performing planar approximation with, respect to 3D information about the plurality of points included in the object region, and determining, by a depth adjusting unit of the image processing apparatus, a second plane by moving the first plane in a first direction in order to readjust a depth of the object region in the first image.

The extracting may include extracting the object region, based on a portion of information from a disparity map associated with the first image, corresponding to the object region of the first image, and color information corresponding to the object region in color information of the first image.

The image processing method may further include generating, by an image synthesizing unit of the image processing apparatus, a second image, by projecting the object region onto the first image based on the second plane, and adjusting a depth of the object region of the first image.

According to still another aspect of the present invention, there is provided an image processing method including extracting, by an object extracting unit of an image processing apparatus, an object region from a first image constituting stereoscopic images, and calculating, by a depth adjusting unit of the image processing apparatus, the changed position of the object region, by applying a scaling factor and a translation factor that are determined to adjust a depth of the object region in the first image to each of a value of an X and Y coordinates corresponding to a horizontal direction and vertical direction of a plurality of points included in the object region, respectively.

### BRIEF DESCRIPTION OF DRAWINGS

These and or other aspects, features, and advantages of the invention will become apparent and more readily appreciated from the following description of exemplary embodiments, taken in conjunction with the accompanying drawings of which:

FIG. 1 is a block diagram illustrating an image processing apparatus according to an embodiment of the present invention;

FIG. 2 is a diagram illustrating stereoscopic images input into an image processing apparatus according to an embodiment of the present invention;

FIG. 3 is a diagram illustrating a process of performing depth adjustment according to an: embodiment of the present invention;

FIG. 4 is a diagram illustrating a process of performing depth adjustment according to another embodiment of the present invention;

FIG. 5 is a diagram illustrating point movement on a plane according to an embodiment of the present invention;

FIG. 6 is a diagram illustrating point movement on a plane according to another embodiment of the present invention;

FIG. 7 is a diagram illustrating an image synthesizing process according to an embodiment of the present invention;

FIG. 8 is a diagram illustrating an example of displacement of objects and cameras in a three-dimensional (3D) space constructed to describe an image processing method according to an embodiment of the present invention;

FIG. 9 is a block diagram illustrating an image processing apparatus according to another embodiment of the present invention;

FIG. 10 is a diagram illustrating stereoscopic images acquired by capturing the 3D space of FIG. 8;

FIG. 11 is a diagram illustrating an example of selecting a region of interest (ROI) from a left image of the stereoscopic images of FIG. 8;

FIG. 12 is a diagram illustrating an example of a result of extracting an object region from the image of FIG. 11;

FIG. 13 is a diagram illustrating a process of performing planar approximation using 3D information of an object region according to an embodiment of the present invention;

FIG. 14 is a diagram illustrating a process of adjusting a depth of an object point in a case of performing plane movement according to an embodiment of the present invention;

FIG. 15 is a diagram illustrating a process of moving an object point in a left image in the case of performing the plane movement of FIG. 14;

FIG. 16 is a diagram illustrating a process of performing plane movement according to an embodiment of the present invention;

FIG. 17 is a diagram illustrating a process of performing plane movement in a camera centric direction according to another embodiment of the present invention;

FIG. 18 is a diagram illustrating a process of filling a portion for which color information is absent when a depth of an object region is adjusted according to an embodiment of the present invention;

FIG. 19 is a flowchart illustrating an image processing method according to an embodiment of the present invention;

FIG. 20 is a flowchart illustrating an image processing method according to another embodiment of the present invention;

FIG. 21 is a flowchart illustrating an image processing method according to still another embodiment of the present invention; and

FIG. 22 is a flowchart illustrating a detailed process of generating a resulting image in the image processing method of FIG. 21.

FIG. 23 is a flowchart illustrating a detailed process of generating a resulting image in the image processing method of FIG. 22

### BEST MODE FOR CARRYING OUT THE INVENTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

FIG. 1 is a block diagram illustrating an image processing apparatus 100 according to an embodiment of the present invention, Referring to FIG. 1, the image processing apparatus 100 may include a plane determining unit 110, a depth adjusting unit 120, and an image synthesizing unit 130. In this instance, the plane determining unit 110 corresponds to an optional element and thus, may be omitted depending on embodiments.

The depth adjusting unit 120 may determine a second point by moving a first point of a first image constituting stereoscopic images in a viewer centric direction, according to a depth adjustment value dₘ. Here, dₘ may denote a degree of the depth adjustment that may be predetermined by a user and/or a system, dₘ may be understood by referring to FIGS. 3 through 6.

The first point may correspond to a point present in the center of a region in the first image, of which a depth is to be adjusted based on the depth adjustment value dₘ. The scheme of performing depth adjustment with respect to the central point of the region of which the depth is to be adjusted, which will be described hereinafter, may be performed identically with respect to other pixels being targets for the depth adjustment.

The depth adjusting unit 120 may determine a third point by projecting the second point onto the first image in a direction from a first viewer's viewpoint associated with the first image to the second point.

A difference between a depth value of the first point and a depth value of the second point may be identical to the depth adjustment value dₘ.

In addition, the depth adjusting unit 120 may determine a scaling factor and a translation factor for moving the first point to the third point, based on a position of the first image, a position of the first viewer's viewpoint, the viewer centric direction, and the depth adjustment value. By determining the scaling factor and the translation factor, image units may be processed more rapidly, when compared to performing the process for each pixel.

The image synthesizing unit 130 may generate a second image which represents the depth adjusted scene obtained from the first image by determining a color value of the third point.

The process of generating the second image will be described in detail with reference to FIG. 3.

The method of moving a first point on a display plane directly in order to adjust a depth of the first point has been described above. According to another embodiment, the depth adjustment may be performed after a first predetermined plane differing from the display plane is determined.

According to the other embodiment, a predetermined plane being separate from the first image may be determined between the first image and the user. In this instance, the image processing apparatus 100 may further include the plane determining unit 110.

The plane determining unit 110 may determine a first predetermined plane parallel to the first image constituting the stereoscopic images.

In this instance, the depth adjusting unit 120 may determine a second point by projecting a first point of the first image onto the first plane in a direction of a first viewer's viewpoint associated with the first image, and may determine a third point by moving the second point in the viewer centric direction, according to a depth adjustment value dₘ.

In this instance, a difference between a depth value of the second point and a depth value of the third point on the first plane may be identical to the depth adjustment value dₘ.

In addition, the depth adjusting unit 120 may determine a fourth point by projecting the third point onto the first image.

The process of determining the fourth point will be described in detail with reference to FIG. 4.

The image synthesizing unit 130 may generate a second image which represents the depth adjusted scene obtained from the first image, by determining a color value of the fourth point.

In this instance, in order to determine the color value of the fourth point, the image synthesizing unit 130 may search for a corresponding pixel by performing hack-tracing with respect to a position of the fourth point in the second image to the first image, and may determine the color value of the fourth point using color values of pixels adjacent to a found pixel.

FIG. 2 illustrates a first image 201 and a third image 202 constituting stereoscopic images according to an embodiment of the present invention.

The first image 201 may be viewed at a first viewer's viewpoint of a user, and the third image 202 may be viewed at second viewer's viewpoint of the user. For example, the first viewer's viewpoint may correspond to a left-eye viewpoint, and the second viewer's viewpoint may correspond to a right-eye viewpoint. The whole first image 201 and the whole third image 202 represents the whole scene of the stereoscopic images. The part of the first image 201 and the part of the third image 202 represents the part of the scene of the stereoscopic images.

The first viewer's viewpoint and the second viewer's viewpoint of the user may correspond to different viewpoints from which a three-dimensional (3D) space is viewed. Accordingly, a disparity may occur in a position of each object 211, 221, 212, or 222 observed in the first image 201 and the third image 202.

The depth adjusting unit 120 of FIG. 1 may select at least one region 203 from the first image 201 and the third image 202, and may adjust a depth of the at least one region 203.

The at least one region 203 may be selected by the user by designating a predetermined form or a predetermined shape, which is not limited to a portion of examples. Furthermore, depending on embodiments, a depth may be adjusted with respect to the entirety of the first image 201, rather than selecting the at least one region 203.

FIG. 3 is a diagram illustrating a process of obtaining a third point 330 by adjusting a depth, of a first point 213 of the first image 201 constituting stereoscopic images based on a viewer's viewpoint according to an embodiment of the present invention.

Herein, a plane on which the first image 201 is to be displayed will be referred to as a display screen 310.

The depth adjusting unit 120 may determine a position of a second point 320 by moving a first point P_{DL} 213 of the first image 201 in a viewer centric direction, that is, in a direction of the center 303 of viewpoints 301, and 302 corresponding to both eyes of a user. Here, a difference between a depth of the second point 320 and a depth of the first point P_{DL} 213 may be identical to a depth adjustment value dₘ.

The depth adjusting unit 120 may determine the third point P′_{DL} 330, by projecting the second point 320 onto the display screen 310, in a direction from the first viewer's viewpoint 301 to the second point 320.

When the process described above is applied to points other than the first point P_{DL} 213, a second image may be generated by adjusting a depth of at least one region of the first image 201 by dₘ.

The process may be identically applied to the third image 202 corresponding to the second viewer's viewpoint 302, among the viewer's viewpoints.

Although the above description has been provided by assuming that the center 303 of the viewer viewpoints is present in a predetermined position, the position of the center 303 is not limited to a portion of examples. For example, the method may be performed assuming that the center 303 is present in a normal direction of the center of a region in the first image 201 that is a target for the depth adjustment.

In particular, the center 303 of the viewer viewpoints may be changed. Accordingly, the method may be performed, for example, assuming that the center 303 is present in the normal direction of the center of the region of which a depth is to be adjusted, without considering the position of the center 303 in real lime.

In this instance, the depth adjustment process described above may be performed simply, by adjusting a depth value of the first point 213 by dₘ in a depth direction, and projecting the second point 320 onto the display screen 310 in a direction from the first viewer viewpoint 301 to the second point 320 in a case of a left-eye image. Although the present instance will not be mentioned any further, following descriptions may be applied, irrespective of the position of the center 303.

FIG. 4 is a diagram illustrating a process of determining a separate predetermined plane L in a process of adjusting a depth of the first image 201 according to another embodiment of the present invention.

When the first image 201 of the stereoscopic images is to be displayed on a display screen 310, the first point P_{DL} 213 of the first image 201 may be projected onto the predetermined plane L. In this instance, a result of projecting the first point P_{DL} 213 onto the predetermined plane L in a direction of the first viewer's viewpoint 301 may correspond to a second point P_{L} 410.

P_{L}=(X_{L}, Y_{L}, Z_{L})^{T} may be computed as expressed by Equation 1,

$${X}_{L} = \frac{{d}_{p}}{d} ( {rx}_{L} + {d}_{e} ) - {d}_{e} , \\ {Y}_{L} = \frac{{d}_{p}}{{d}_{v}} ( r {y}_{L} ) , \\ {Z}_{L} = {d}_{p} \qquad [ Equation 1 ]$$

In Equation 1, d_{P} denotes a distance from a viewer's viewpoint, for example the first viewer's viewpoint 301 or the second viewer's viewpoint 302, to the predetermined plane L, and 2d_{c} denotes a distance between the viewer's viewpoints corresponding to both eyes of the user, for example, the first viewer's viewpoint 301 and the second viewer's viewpoint 302.

In addition, r denotes a screen magnification factor to transform from image coordinates to screen display coordinates.

The depth adjusting unit 120 may determine a position of a third point P″_{L} 420, by moving the second point P_{L} 410 in the viewer centric direction, corresponding to a direction of the center 303 of viewpoints 301 and 302 corresponding to both eyes of the user, so that the difference in depth values may correspond to dₘ. Accordingly, a difference between a depth of the second point P_{L} 410 and a depth of the third point P″_{L} 420 may be identical to the predetermined depth adjustment value dₘ.

The depth adjusting unit 120 determines a fourth point P′_{DL} 430 by projecting the third point P″_{L} 420 onto the display screen 310, in a direction from the first viewer viewpoint 301 to the third point P″_{L} 420.

The computed position of the fourth point P′_{DL} 430 may correspond to a result of adjusting a depth of the first point P′_{DL} 213 based on the depth adjustment value dₘ.

Although the second point P_{L} 410 on the virtual parallel plane L may be moved in a Z coordinate direction based on the depth adjustment value dₘ, the second point P_{L} 410 may be moved in the viewer centric direction, that is, in a direction of the center 303 of the viewpoints 301 and 302 corresponding to both eyes of the viewer, in order to minimize loss of color information resulting from the plane movement, that is, an occurrence of disocculusion.

The process described above will be described with reference to FIGS. 5 and 6.

FIG. 5 is a diagram illustrating a process of moving a plane L according to an embodiment of the present invention.

When a predetermined plane 1, onto which the first image 201 is projected is moved in a Z coordinate direction, that is, an optical, axis direction, corresponding to a depth direction, an empty region Rₑ may be occurred in a resulting image.

Since the empty region Rₑ may fail to include color information, only black may remain.

Conversely, a process of performing plane movement in a direction of the center 303 of viewpoints corresponding to both eyes of a viewer according to another embodiment of the present invention will be described with reference to FIG. 6.

According to the other embodiment, in order to minimize the empty region Rₑ, a second point P_{L} 410 may be determined in a region corresponding to the first image 201 on the plane L, and a third point P″_{L}=(X″_{L}, Y″_{L}, Z″_{L})^{T} 420 may be determined, by moving in a direction of the second point 410 and the viewer centric direction.

The third point 420 may be computed by Equation 2.

$${X}_{L}^{″} = \frac{{d}_{p}}{{d}_{v}} ( r {x}_{L} + {d}_{e} ) - {d}_{e} + {d}_{x} , \\ {Y}_{L}^{″} = \frac{{d}_{p}}{{d}_{v}} ( r {x}_{L} ) + {d}_{y} , \\ {Z}_{L}^{″} = {d}_{p} - {d}_{m} \qquad [ Equation 2 ]$$

In Equation 2, dₓ and d_{y} denote movement distances on an X axis and a Y axis, respectively.

The second point may be set to a predetermined position that may represent an image region for which 3D depth adjustment is desired to be performed, and may be set to any positions of the image region, for example, a central point, a left corner point, a right corner point, and the like. In addition, the second point may be processed in the first image 201 and the third image 202, in different manners.

When a portion of the empty region Rₑ remains although the empty region Rₑ is minimized by the scheme described above, hole filling may be performed to remove the empty region Rₑ using color information of adjacent regions.

The fourth point P′_{L}=(x′_{L}, y′_{L})^{T} in the second image obtained by performing 3D depth adjustment may be obtained from the third point P″_{L} 420, as expressed by Equation 3 [Equation 3]

$${x}_{L}^{′} = \frac{{d}_{p}}{{d}_{p} - {d}_{m}} \cdot {x}_{L} + \frac{{d}_{m}}{{d}_{p} - {d}_{m}} \cdot \frac{{d}_{e}}{r} + \frac{{d}_{v}}{{d}_{p} - {d}_{m}} \cdot \frac{{d}_{X}}{r} , \\ {y}_{L}^{′} = \frac{{d}_{p}}{{d}_{p} - {d}_{m}} \cdot {y}_{L} + \frac{{d}_{v}}{{d}_{p} - {d}_{m}} \cdot \frac{{d}_{Y}}{r} . \qquad [ Equation 3 ]$$

Similarly, a 3D depth adjustment process with respect to the third image 202 may be performed. Position of P′_{R}=(x′_{R}, y′_{R}) in the second image obtained by performing 3D depth adjustment of the third image may be computed, as expressed by Equation 4.

$${x}_{R}^{′} = \frac{{d}_{p}}{{d}_{p} - {d}_{m}} \cdot {x}_{R} + \frac{{d}_{m}}{{d}_{p} - {d}_{m}} \cdot \frac{{d}_{e}}{r} + \frac{{d}_{v}}{{d}_{p} - {d}_{m}} \cdot \frac{{d}_{X}}{r} , \\ {y}_{R}^{′} = \frac{{d}_{p}}{{d}_{p} - {d}_{m}} \cdot {y}_{R} + \frac{{d}_{v}}{{d}_{p} - {d}_{m}} \cdot \frac{{d}_{Y}}{r} . \qquad [ Equation 4 ]$$

As shown in Equation 3 and Equation 4, a distance dᵥ between both eyes of the user and the display screen 301 may not affect the computation of position of the points in the second image which represents the depth adjusted scene obtained from the first image and the third image.

Accordingly, the distance from both eyes of the user and the 3D display screen 301 may be set randomly.

FIG. 7 is a diagram illustrating a process of filling portions in which color information is absent after a depth of at least one region of a first image is adjusted according to an embodiment of the present invention. The image synthesizing unit 130 may determine a color value of a second image 702 which represents the depth adjusted scene obtained from the first image 701, based on a color value of the first image 701.

In this instance, a point 713 may be determined, by performing back-tracing with respect to a position of a pixel 723 in the second image 702, for which a color value is to be determined, to the first image 701 before the depth adjustment is performed, and the color value of the pixel 723 may be determined using color values of pixels adjacent to the determined point 713.

When a pixel 722 of an object 721 corresponds to a portion 712 of the identical object 711 in the first image 701, a color value of the portion 712 may be copied.

In a case of performing depth adjustment with respect to only a partial region 710, the aforementioned factors may be determined with regard to objects in a corresponding region 720.

FIG. 8 is a diagram illustrating an example of displacement of objects and cameras in a 3D space 800 constructed to describe an image processing method according to an embodiment of the present invention.

Referring to FIG. 8, an object 810 and an object 820 are displaced in the 3D space 800.

A left image and a right image may be generated, respectively, by capturing the objects 810 and 820 using a left view camera 801 and a right view camera 802, whereby stereoscopic images may be realized.

The left view camera 801 and the right view camera 802 may be construed as parallel stereo cameras, which is a device to generate stereoscopic images in view of a disparity between a left eye and a right eye of a human.

However, the scope is not construed as being limited to a special type of camera is realization, and the camera realization described herein and illustrated through the drawings is provided only as an example.

In addition, the process of adjusting a depth of an image according to example embodiments may be applied to not only stereoscopic images but also at least one view image among multi-view images, identically.

Accordingly, hereinafter, although example embodiments are described using an example of a single view image of stereoscopic images, various modifications and variations can be made without departing from the spirit or scope of the invention, and the modifications and variations are construed as being within the scope of the present invention.

FIG. 9 is a block diagram illustrating an image processing apparatus 900 according to another embodiment of the present invention.

An object extracting unit 910 of the image processing apparatus 900 may extract at least on one object region from a left view image, among the left view image and a right view image constituting an input first image, for example, stereoscopic images.

The process of extracting of the at least one object region may correspond to a process of extracting a region of at least one object within a region of interest (ROI) that is selected in advance, which will be described in detail with reference to FIGS. 10 through 12.

A planar approximation unit 920 may perform planar approximation using 3D point information of the extracted object region. The planar approximation process will be described in detail with reference to FIG. 13, and may be performed, for example, by applying the least squares method, and the like to the 3D point information of the object it region.

A depth adjusting unit 930 may perform depth adjustment with respect to the object region, through plane movement, using a result of the planar approximation. The depth adjustment process will be described in detail with reference to FIGS. 14 through 17.

An image synthesizing unit 940 may generate a second image which represents the depth adjusted scene obtained from the first image. The process of generating the second image will be described in detail with reference to FIG. 18.

According to another example embodiment, the depth adjusting unit 930 may adjust the depth of the object region, by applying a scaling factor and a translation factor to the extracted object region, without performing the planar approximation.

In this instance, the depth adjustment may be performed efficiently and rapidly, without assigning resources to accurate computation of a disparity map requiring a heavy computation. In addition, loss of color information may be minimized during the depth adjustment process and thus, a natural resulting image may be generated.

The present example embodiment will be described in detail with reference to FIG. 14, and the subsequent drawings.

The image synthesizing unit 940 may determine pixel values of the second image, by applying ray tracing, and the like depending on example embodiments, which will be described in detail with reference to FIG. 18.

Hereinafter, the depth adjustment process will be described using detailed examples in order to describe concepts of example embodiments.

FIG. 10 is a diagram illustrating stereoscopic images 1001 and 1002 acquired by capturing the 3D space 800 of FIG. 8.

For example, the left image 1001 may correspond to an image captured by the left view camera 801 of FIG. 8, and the right image 1002 may correspond to an image captured by the right view camera 802 of FIG. 8

Since the left view camera 801 and the right view camera 208 may view the 3D space 800 from different viewpoints, a disparity may be observed at positions of the objects 810 and 820 in the left image 1001 and the right image 1002.

The disparity may increase as a distance from the left view camera 801 and the right view camera 802 decreases, and conversely, the display may decrease as the distance from the left view camera 801 and the right view camera 802 increases.

Accordingly, as shown in FIG. 10, the object 810 that is displaced relatively close to the cameras 801 and 802 may be present at a position of an object 1011 in the left view image 1001, however, may be present at a position of an object 1021 in the right view image 1002. A disparity between the two images 1001 and 1002 may be relatively great.

Since the object 820 is displaced relatively far from the cameras 801 and 802, a disparity between an object 1021 in the left view image 1001 and an object 1022 in the right view image 1002 may be less than the case of the object 810.

From the left view image 1001 and/or the right view image 1002, image processing may be performed to adjust a depth of at least one of the objects 810, 820, and the like.

Hereinafter, although the left view image 1001 is used as an example for describing an image processing method, the image processing method may be applied identically to the right view image 1002, or various view images (not shown) constituting a multi-view image. Hereinafter, the left view image 1001 to be used as an example will be referred to as a first image.

The object extracting unit 910 of FIG. 9 may adjust a depth of the object 810 in a 3D image, by extracting an object region, for example, a region corresponding to the object 1011, from the first image 1001.

The object region may be extracted from an RO that is set by a user. Hereinafter, although only example embodiments of extracting an object from an ROI are described, the present invention is not limited thereto. Unless otherwise mentioned, it should be understood that an object may be extracted from a predetermined region of the first image 1001, and that a plurality of object regions as well as a single object region may be extracted.

FIG. 11 is a diagram illustrating an example of selecting an ROI from a left image of the stereoscopic images of FIG. 8.

A user may set an ROI 1110 with respect to an image 1001. The ROI 1110 may be set by selecting a region in a predetermined shape using a user interface device, for example, a user input device such as a mouse, or a touch screen.

For example, the user may designate the ROI 1110 of a rectangular shape. As another example, the user may designate the ROI 1110 of a predetermined shape. The scheme of designating the ROI 1110 is not limited to a portion of examples.

In addition, as described above, designating the ROI 1110 is not compulsory The ROI 1110 may be set by a predetermined scheme, for example, in order to increase an accuracy for extracting the region corresponding to the object 1011, and/or in order to designate an object whose the depth is desired to be adjusted to be distinguished from other objects.

The object extracting unit 910 may extract the region corresponding to the object 1011 within the set ROI 1110, from the input image 1001.

FIG. 12 is a diagram illustrating an example of a result 1200 of extracting an object region 1210 from the image 1001 of FIG. 11.

When the region corresponding to the object 1011 is extracted from the ROI 1110 of the input image 1001, the object extracting unit 910 may extract the object region 1210, by performing the k-means algorithm with respect to color information in an image, and a disparity map that may be obtained using a simple dynamic programming.

In a case of extracting the extracted object region 1210, the disparity map may be more reliable in the image 1001 which has enough texture. Conversely, in the image 1001 which is lack of texture, the color information may be more reliable.

Accordingly, the extracted object region 1210 may be extracted using both the disparity map and the color information. For example, a result of extracting the extracted object region 1210 may correspond to a binary image including information for distinguishing the extracted object region 1210 from the other regions, as shown, in the result 1200.

The object extracting unit 910 may perform varied pre-processing in order to increase reliability of the result 1200 of extracting the object region.

For example, the object extracting unit 910 may perform pre-processing, for example, erosion, dilation, and the like, on the result 1200 to minimize noise effects.

In addition, according to another example embodiment, when the result 1200 of extracting the object region is unsatisfactory, the user may modify the extracted object region 1210, directly.

When the object region 1210 is extracted, the planar approximation unit 920 may perform the planar approximation with respect to 3D information of points included in the object region 1210, for example, spatial position of the points.

Since the planar approximation is performed, a result of an image processing method to be described later is less sensitive to an accuracy of the disparity map for the extracted object region 1210.

The planar approximation will be described in detail with reference to FIG. 13.

FIG. 13 is a diagram illustrating a process of performing planar approximation using 3D information of an object region according to an embodiment of the present invention.

The planar approximation unit 920 may perform approximation by a first plane L1, by applying the least squares method to points 1310 corresponding to the object region 1210.

A predetermined point Pᵢ=(Xᵢ, Yᵢ, Zᵢ)^{T} denotes 3D spatial position of an i^{th} point, among object points included in an object region 510. When the total number of the objects points 610 corresponds to N, a first plane equation may be computed using the least squares method, as expressed by Equation 5.

ax+by+cz=1 [Equation 5]

A process of applying the least squares method to the plane equation may be expressed by Equation 6.

$${arg}_{a , b , c} min {\sum }_{i = 1}^{N} {( a {X}_{i} + b {Y}_{i} + c {Z}_{i} - 1 )}^{2} \qquad [ Equation 6 ]$$

In the majority of cases, plane coefficients a, and b obtained by the least squares method may have almost zero values. Transitively, according to the present embodiment, a depth dₚ of a plane approximated based on a plane coefficient c may be computed, as expressed by Equation 7. However, the present invention is not limited to the present embodiment, and the present embodiment is provided only as an example. Accordingly, accurate values of a, b, and c may be obtained as well. Hereinafter, the description will be provided by simplifying the coefficients, as expressed by Equation 7.

$$a = 0 , b = 0 , c = \frac{1}{{d}_{p}} \qquad [ Equation 7 ]$$

In contrast to a conventional method of performing the 3D reconstruction and adjusting a depth by moving an object in a 3D space in point units, the points 1310 of the object may be approximated by the plane L1, and the plane L1 may be pushed or pulled to adjust a 3D depth. Accordingly, an amount of computation may be greatly reduced.

When the approximated plane L1 is moved by dₘ to adjust the 3D depth of the object, the plane coefficients in Equation 7 may be changed, as expressed by Equation 8,

$$a = 0 , b = 0 , c = \frac{1}{{d}_{p} - {d}_{m}} \qquad [ Equation 8 ]$$

Applying the coefficients in Equation 8 to Equation 5, a plane equation of a second plane L2 obtained by moving the approximated first plane L1 by dₘ may be expressed by z/(dp−dm)=1.

The second plane L2 will be described in detail with reference to FIG. 14.

FIG. 14 is a diagram illustrating a process of adjusting a depth of an object point Pᵢ in a case of performing plane movement according to an embodiment of the present invention, and FIG. 15 is a diagram illustrating a process of moving an object point in a left image in the case of performing the plane movement of FIG. 14.

The following description will be provided with reference to FIGS. 14 and 15.

When the origin O in a global coordinate system corresponds to (X, Y, Z)^{T}=(0, 0, 0)^{T}, position of C_{L} of a left view camera may correspond to (−dc, 0, 0), and position of C_{R} of a right view camera may correspond to (dc, 0, 0).

When a central point of an image coordinate system (x, y)^{T} in a first image is positioned in the center of each view image, the object point Pᵢ=(Xᵢ, Yᵢ, Zᵢ)^{T} may be projected onto P_{L}=(X_{L}, Y_{L})^{T} in a left view image 1500. Although not shown in FIG. 15, the object point Pᵢ=(Xᵢ, Yᵢ, Zᵢ)^{T} may be projected onto P_{R}=(X_{R}, Y_{R})^{T} in a right view image.

When the point P_{L} is projected onto P_{L} on the approximated first plane L1, in the left view image 1500, P_{L}=(X_{L}, Y_{L}, Z_{L})^{T} may be computed, as expressed by Equation 9,

$${X}_{L} = \frac{{d}_{p}}{f} \cdot \frac{{x}_{L}}{r} - {d}_{c} , {Y}_{L} = \frac{{d}_{p}}{f} \cdot \frac{{y}_{L}}{r} , {Z}_{L} = {d}_{p} \qquad [ Equation 9 ]$$

In Equation 9, f denotes a focal distance, 2dc denotes a distance between a position C_{L} of the left view camera and a position C_{R} of the right view camera, and r denotes a scale ratio coefficient between an image coordinate system of a camera and an image coordinate system of stereoscopic images.

When the approximated first plane L1 is moved by dₘ to adjust the 3D depth of the object, the point P_{L} on the approximated plane L1 that is expressed by Equation 9 may be moved to a point P′_{L}=(X′_{L}, Y′_{L}, Z′_{L})^{T} only in a Z coordinate direction, as expressed by Equation 10.

$${X}_{L}^{′} = \frac{{d}_{p}}{f} \cdot \frac{{x}_{L}}{r} - {d}_{c} , {Y}_{L}^{′} = \frac{{d}_{p}}{f} \cdot \frac{{y}_{L}}{r} , {Z}_{L}^{′} = {d}_{p} - {d}_{m} \qquad [ Equation 10 ]$$

When the point Pᵢ=(Xᵢ, Yᵢ, Zᵢ) in the 3D space is provided, two points P_{L}=(X_{L}, Y_{L})^{T} and P_{R}=(X_{R}, Y_{R})^{T} projected onto a left image plane and a right image plane may be expressed by Equation 11.

$${x}_{L} = \frac{rf}{{Z}_{i}} ( {X}_{i} + {d}_{c} ) , {y}_{L} = \frac{rf}{{Z}_{i}} {Y}_{i} , \\ {x}_{R} = \frac{rf}{{Z}_{i}} ( {X}_{i} - {d}_{c} ) , {y}_{R} = \frac{rf}{{Z}_{i}} {Y}_{i} \qquad [ Equation 11 ]$$

Position of P′_{L}=(X′_{L}, Y′_{L})^{T} of a new point P′_{L} on a second plane L2 whose 3D depth is adjusted, as shown in FIG. 14, may be computed using Equation 11, as expressed by Equation 12,

$${x}_{L}^{′} = \frac{{d}_{p}}{{d}_{p} - {d}_{m}} \cdot {x}_{L} , {y}_{L}^{′} = \frac{{d}_{p}}{{d}_{p} - {d}_{m}} \cdot {y}_{L} , \\ {x}_{R}^{′} = \frac{{d}_{p}}{{d}_{p} - {d}_{m}} \cdot {x}_{R} , {y}_{R}^{′} = \frac{{d}_{p}}{{d}_{p} - {d}_{m}} \cdot {y}_{R} \qquad [ Equation 12 ]$$

Although not shown in FIG. 15, the position of a new point P′_{R}=(X′_{R}, Y′_{R})^{T} with respect to the point P_{R}=(X_{R}, Y_{R})^{T} on the right image may be similarly computed as well.

When the position of the new point P′_{L} and the position of the new point P′_{R} are computed, the depth of the point Pᵢ may be adjusted, and a position of a point P′ᵢ that may be recognized by the viewer may be computed using Equation 9 and Equation 12, as expressed by Equation 13.

$${X}_{i}^{′} = {X}_{i} , {Y}_{i}^{′} = {Y}_{i} , {Z}_{i}^{′} = {Z}_{i} \frac{( {d}_{p} - {d}_{m} )}{{d}_{p}} \qquad [ Equation 13 ]$$

Comparing newly computed Z′ and Z, it may be understood that the depth of the point is adjusted simply by dₘ.

According to another example embodiment, the depth adjustment process may be performed by applying a scaling factor to each of pixels in the region corresponding to the object 1011 in the image 1001.

When the scaling factor is defined as s=dₚ/(dₚ−dₘ), Equation 11 may be expressed, as Equation 14.

x′_{L}=s·x_{L}, y′_{L}=s·y_{L},

x′_{R}=s·x_{R}, y′_{R}=s·y_{R}

That is, a process of generating stereoscopic images whose 3D depth is changed by dₘ by performing planar approximation on object points may be identical to a process of transforming the position of an object in an image by a factor of s, based on the origin of each of the original left stereoscopic image and the original right stereoscopic image.

The above process may be performed by the depth adjusting unit 930 of the image processing apparatus 900 of FIG. 9.

According to an example embodiment, the depth adjusting unit 930 may move the plane in a Z coordinate direction during the plane movement process. According to another example embodiment, the depth adjusting unit 930 may move the plane in a direction of the camera point C_{L} in order to minimize loss of color information resulting from the plane movement, that is, occurrence of disocculusion.

The processes described above will be further described with reference to FIGS. 16 and 17.

FIG. 16 is a diagram illustrating a process of performing plane movement according to an embodiment of the present invention.

When a new object region R′ₒ is generated by moving an object region Rₒ corresponding to an approximated first plane L1 in a Z coordinate direction, that is, an optical axis direction, an empty region Rₑ may be occurred in a resulting image.

Since the empty region Rₑ may fail to include color information, only black may remain.

FIG. 17 is a diagram illustrating a process of performing plane movement in a camera centric direction according to another embodiment of the present invention.

According to the present embodiment, in order to minimize an empty region Rₑ, a first point representing an object region Rₒ on a plane L1 may be determined, and a new object region R′ₒ may be generated by moving the object region Rₒ in a first direction connecting the first point and a camera point C_{L}.

Here, the first point may be set to a predetermined point that may represent the object region Rₒ, and may be set to, for example, a central point, a left corner point, a right corner point, and the like of the object region Rₒ. In addition, the first point is not limited to a point within the object region Rₒ, and may correspond to a predetermined point on the first plane L1. Setting of the first point may be performed in the left view image and the right view image, in different manners.

A point may be set to a point that may minimize the empty region Rₑ in the resulting image.

When a portion of the empty region Rₑ remains, although the empty region Rₑ is minimized by the scheme described above, hole filling may be performed to remove the empty region Rₑ using color information of adjacent regions.

As described with reference to Equation 14, according to an example embodiment, the image processing may be performed by applying a scaling factor to pixels in the object region. According to another example embodiment, the image processing may be performed by applying a translation factor in addition to the scaling factor, in order to minimize the empty region Rₑ.

When a second plane is determined by moving the approximated first plane L1 of FIG. 14 by dₘ in a Z coordinate direction, distances by which a left plane and a right plane are moved along an X axis and a Y axis in a 3D space, in order to provide effects similar to the object region Ro being moved in the direction of the camera point C_{L}, may correspond to (dₓ, d_{y}) and (−dₓ, d_{y}), respectively. In this instance, Equation 10 may be rewritten, as expressed by Equation 15.

$${X}_{L}^{′} = \frac{{d}_{p}}{f} \cdot \frac{{x}_{L}}{r} - {d}_{c} + {d}_{X} , {Y}_{L}^{′} = \frac{{d}_{p}}{f} \cdot \frac{{y}_{L}}{r} + {d}_{Y} , \\ {Z}_{L}^{′} = {d}_{p} - {d}_{m} \\ {X}_{R}^{′} = \frac{{d}_{p}}{f} \cdot \frac{{x}_{R}}{r} - {d}_{c} + {d}_{X} , {Y}_{R}^{′} = \frac{{d}_{p}}{f} \cdot \frac{{y}_{R}}{r} + {d}_{Y} , \\ {Z}_{R}^{′} = {d}_{p} - {d}_{m} \qquad [ Equation 15 ]$$

Accordingly, pixel P′_{L}=(X′_{L}, Y′_{L})^{T} and P′_{R}=(X′_{R}, Y′_{R}) on new stereoscopic images may be computed using Equation 11, as expressed by Equation 16,

$${x}_{L}^{′} = \frac{{d}_{p}}{{d}_{p} - {d}_{m}} {x}_{L} + \frac{rf \cdot {d}_{X}}{{d}_{p} - {d}_{m}} , \\ {y}_{L}^{′} = \frac{{d}_{p}}{{d}_{p} - {d}_{m}} \cdot {y}_{L} + \frac{rf \cdot {d}_{Y}}{{d}_{p} - {d}_{m}} , \\ {x}_{R}^{′} = \frac{{d}_{p}}{{d}_{p} - {d}_{m}} {x}_{R} + \frac{rf \cdot {d}_{X}}{{d}_{p} - {d}_{m}} , \\ {y}_{R}^{′} = \frac{{d}_{p}}{{d}_{p} - {d}_{m}} \cdot {y}_{R} + \frac{rf \cdot {d}_{Y}}{{d}_{p} - {d}_{m}} \qquad [ Equation 16 ]$$

In addition, when the scaling vector s=dₚ/(dₚ−dₘ), a translation factor tₓ=rf*dₓ/(dₚ−dₘ), and a translation factor t_{y}=rf*dy/(dp−dm) are defined, Equation 16 may be expressed by Equation 17.

x′_{L}=s·x_{L}+tₓ, y′_{L}=s·y_{L}+t_{y},

x′_{R}=s·x_{R}+tₓ, y′_{R}=s·y_{R}+t_{y} [Equation 17]

That is, a process of generating stereoscopic images whose 3D depth is changed by dₘ by performing planar approximation on an object may be identical to a process of transforming the position of the object in an image by a factor of s, based on the origin of each of the original left stereoscopic image and the original right stereoscopic image, and moving the coordinates by tₓ and t_{y} in an X coordinate direction and a Y coordinate direction, respectively.

In this instance, when the object is pulled to be closer, a range of dₘ may be determined to be 0<dₘ<dₚ. Accordingly, a range of s may be determined to be s>1. Conversely, when the object is pushed farther away, a range of dₘ may correspond to dₘ>0 and thus, a range of s may be determined to be 0<s<1.

According to an example embodiment, by performing scale conversion by applying the scaling factor, and performing movement by applying the translation factors, with respect to each pixel within the object region in the image coordinate system of the stereoscopic images, based on Equation 17, a result identical to a result of performing the plane movement, and the like may be achieved.

The scale conversion may be performed by a factor of s, by applying the scaling factor, with respect to each pixel of the extracted object region, based on a degree of depth adjustment desired by the user.

In order to minimize an empty region that may be occurred in a resulting image after the scale conversion is performed, translation factors tₓ and t_{y} that may move a central point of the object region after the scale conversion is performed to a central point of an original object region may be obtained, and each pixel may be moved using the translation factors. According to the present example embodiment, a result similar to a result of the method of adjusting the depth of the object based on the planar approximation may be obtained as well.

Hereinafter, the process described above will be described in detail. According to the example embodiments described above, planar approximation may be performed in a 3D space with respect to the object extracted from at least one view image, among the provided stereoscopic images, the approximated plane may be moved forward or backward, and a new image may be generated by projecting the object region on the view image.

However, according to other example embodiments, the process may be simplified to be more general, and may be construed as a process of applying the scaling factor and the translation factors.

The scaling factor and translation factors have been described above in detail, and a description as to a portion of color information of an image being lost after the scaling factor and the translation factors are applied during the process, such that holes may be occurred in the image, is also provided.

Accordingly, with respect to the other example embodiments, ray tracing may be employed to adjust corresponding color information from the original view image, by inversely tracing the process of applying the scaling actor and the translation factors, starting from each pixel of a resulting image to be newly generated.

FIG. 18 is a diagram illustrating a process of filling a portion for which color information is absent when a depth of an object region is adjusted according to an embodiment of the present invention.

Referring to FIG. 18, an object region 1821 may be generated within a resulting image 1802, by applying a scaling factor and a translation factor to an object region 1811 in an original view image 1801, through the process described above.

In order to fill a hole whose color information is absent, occurred during the process, the image synthesizing unit 940 may perform back-tracing to copy color information from the original view image 1801.

When the depth adjustment process is performed with respect to the object region 1811 of the original view image 1801, color information for a hole occurred in the resulting image 1802 may be determined through the following process.

When a distance dₘ for performing the depth adjustment is provided, a pixel value of each pixel in at least one region of the resulting image 1802 to be generated, for example, a pixel value at pixel P′_{L}=(X′_{L}, Y′_{L})^{T} of each pixel in an ROI 1820, may be determined, by determining a pixel P′_{L}=(X_{L}, Y_{L})^{T} in the original view image 1801 using an inverse function of Equation 16, as expressed by Equation 18, and copy a value of the determined pixel.

In addition, although not shown in FIG. 18, in a case of another view image, a pixel P_{R}=(X_{R}, Y_{R})^{T} in an original view image may be determined using an inverse function of Equation 16, and a value of the determined pixel may be copied, with respect to pixel P′_{R}=(X′_{R}, Y′_{R})^{T}.

$${x}_{L} = \frac{{d}_{p} - {d}_{m}}{{d}_{p}} {x}_{L}^{′} - \frac{rf \cdot {d}_{X}}{{d}_{p}} , \\ {y}_{L} = \frac{{d}_{p} - {d}_{m}}{{d}_{p}} {y}_{L}^{′} - \frac{rf \cdot {d}_{Y}}{{d}_{p}} , \\ {x}_{R} = \frac{{d}_{p} - {d}_{m}}{{d}_{p}} {x}_{R}^{′} + \frac{rf \cdot {d}_{X}}{{d}_{p}} , \\ {y}_{R} = \frac{{d}_{p} - {d}_{m}}{{d}_{p}} {y}_{R}^{′} - \frac{rf \cdot {d}_{Y}}{{d}_{p}} \qquad [ Equation 18 ]$$

In the process of determining the pixel value, when P_{L} or P_{R} is included in the object region 1811, a pixel value of P_{L} or P_{R} may be copied to be determined to be a pixel value of P′_{L} or P′_{R}.

In this instance, when the pixel value of P′_{L} or P′_{R} does not correspond to an integer, bilinear interpolation using information of adjacent pixels may be used to determined the pixel value.

When P_{L} or P_{R} is not included in the object region 1811, the pixel value of P_{L} or P_{R} may not be copied, and hole filling may be performed using the adjacent pixels.

In addition, as shown in Equation 17, the process of generating the stereoscopic images whose the depth is changed by dₘ by performing planar approximation on an object may be identical to a process of performing scale conversion by a factor of s on the object based on each origin, in the left stereoscopic image and the right stereoscopic image before the depth adjustment, and moving the object image by tₓ and t_{y} in an X coordinate direction and a Y coordinate direction, respectively.

Accordingly, the ray-tracing may be applied through the scale conversion and image movement of the object.

In this instance, the inverse function of Equation 17 may be defined first, as expressed by Equation 19, the pixel P_{L} or P_{R} in the original stereoscopic images corresponding to a pixel P′_{L} or P′_{R} in the stereoscopic images to be generated may be computed, using the Equation 19, whereby a value of the corresponding pixel P_{L} or P_{R} may be copied.

$${x}_{L} = \frac{1}{s} {x}_{L}^{′} - \frac{{t}_{x}}{s} , {y}_{L} = \frac{1}{s} {y}_{L}^{′} - \frac{{t}_{y}}{s} , \\ {x}_{R} = \frac{1}{s} {x}_{R}^{′} - \frac{{t}_{x}}{s} , {y}_{R} = \frac{1}{s} {y}_{R}^{′} - \frac{{t}_{y}}{s} , \qquad [ Equation 19 ]$$

The pixel value may be copied by performing ray-tracing with respect to all pixels in the stereoscopic images to be newly generated. However, when the object region 1821 or the ROI 1820 in the resulting image 1802 corresponding to the object region 1811 or the ROI 1810 in the original view image 1801 may be estimated to an approximate value using Equation 16, computation may be reduced by performing ray-tracing with respect to only corresponding regions as shown in FIG. 18.

FIG. 19 is a flowchart illustrating an image processing method according to an embodiment of the present invention.

In operation 1910, the depth adjusting unit 120 may determine a second point by moving a first point of a first image constituting stereoscopic images in a viewer centric direction, according to a depth adjustment value dₘ.

In this instance, a difference between a depth value of the first point and a depth value of the second point may be identical to the depth adjustment value dₘ.

In operation 1920, the depth adjusting unit 120 may determine a third point by projecting the second point onto the first image in a direction from a first viewer's viewpoint associated with the first image to the second point.

The process of determining the second point and the third point has been described with reference to FIGS. 3 and 4.

The depth adjusting unit 120 may determine a scaling factor and a translation factor for moving the first point to the third point, based on a position of the first image, a position of the first viewer's viewpoint, the viewer centric direction, and the depth adjustment value.

In operation 1930, the image synthesizing unit 130 may generate a second image which represents the depth adjusted scene obtained from the first image by determining a color value of the third point.

FIG. 20 is a flowchart illustrating an image processing method according to another embodiment of the present invention.

In the embodiment described with reference to FIG. 19, a method of moving the first point on a display plane directly, in order to adjust the depth of the first point on the display plane, is provided. However, according to the present embodiments described with reference to 20, a first plane differing from the display plane may be determined, and the depth adjustment may be performed.

In operation 2010, the plane determining unit 110 of the image processing apparatus 100 may determine a first plane corresponding to a predetermined plane separate from the first image may be determined between the first image and a viewer. In this instance, the first plane may correspond to a predetermined plane parallel to the first image constituting the stereoscopic images.

In operation 2020, the depth adjusting unit 120 may determine a second point by projecting a first point of the first image onto the first plane in a direction of a first viewers viewpoint associated with the first image, and may determine a third point by moving the second point in a viewer centric direction, according to a depth adjustment value dₘ.

Here, a difference between a depth value of the second point and a depth value of the third point on the first plane may be identical to the depth adjustment value dₘ.

In addition, the depth adjusting unit 120 may determine a fourth point by projecting the third point onto the first image.

In operation 2030, the image synthesizing unit 130 may generate a second image which represents the depth adjusted scene obtained from the first image by determining a color value of the fourth point.

FIG. 21 is a flowchart illustrating an image processing method according to still another embodiment of the present invention.

In operation 2110, the object extracting unit 910 may extract at least one object region from a first image that is input, for example, a left view image constituting stereoscopic images.

The process of extracting the at least one object region may correspond to a process of extracting a region with respect to at least one object within an ROI that is selected in advance. A detailed description in this regard is provided above with reference to FIGS. 8 through 12.

In operation 2120, the planar approximation unit 920 may perform planar approximation using 3D point information of the extracted object region. The planar approximation process is described above with reference to FIG. 13, along with methods, for example, the least squares method, and the like that may be employed.

In operation 2130, the depth adjusting unit 930 may adjust a depth of the object region through plane movement, using a result of performing the planar approximation. The depth adjustment process is described above with reference to FIGS. 14 through 17.

In operation 2140, the image synthesizing unit 940 may generate a second image which represents the depth adjusted scene obtained from the first image. The synthesizing process has been described with reference to FIG. 18, and the like.

FIG. 22 is a flowchart illustrating an image processing method according to yet another embodiment of the present invention.

As described above, according to the present embodiment, without performing a process of determining a first plane through planar approximation after an object region is extracted, and determining a second plane by performing plane movement, an identical result may be obtained by applying a scaling factor and a translation factor to the object region.

In operation 2210, a process of extracting an object region by the object extracting unit 910 may be identical to the embodiment described above.

In operation 2220, the depth adjusting unit 930 may apply a scaling factor is determined based on a degree of depth adjustment, to each pixel in the object region.

In operation 2230, the depth, adjusting unit 930 may apply translation factors tₓ and t_{y} to each pixel in the object region.

The process of applying the scaling factor and the translation factors is described above with reference to FIGS. 14 through 17, and Equations 15 through 18, and the like. Through the aforementioned process, the depth of the object region may be adjusted.

In operation 2240, pixel values in a second image may be determined through a ray-tracing process.

The process of generating a resulting image in operation 2240, for example, the ray-tracing process, is described above with reference to FIG. 18, and the like. The process of generating the resulting image will be described with reference to a detailed flowchart of FIG. 23.

FIG. 23 is a flowchart illustrating a detailed process of generating a resulting image in the image processing method of FIG. 22.

In operation 2310, a pixel P′ᵢ in a second image may be selected. In operation 2220, Pᵢ corresponding to a position of a pixel before a scaling factor and a translation factor are applied to the selected pixel P′ᵢ may be determined through a process of obtaining the inverse function.

In operation 2320, whether Pᵢ corresponding to the position of the pixel is positioned within the object region may be determined.

When Pᵢ is present within the object region, a value of the pixel Pᵢ in the first image being the original image may be returned to be a value of a pixel P′ᵢ in a new second image, in operation 2330.

When Pᵢ is absent within the object region, a value of the pixel P′ᵢ may be computed directly, in operation 2350. In this instance, the computation may be performed by interpolation using adjacent pixels.

In operation 2340, the value of the pixel P′ᵢ may be determined finally, by returning the pixel value or the computation. When the process is performed iteratively with respect to all pixels in the second image, or with respect to all pixels in an ROI or an object region according to another example embodiment, pixel information of the second image may be determined.

A detailed description is provided above with reference to FIG. 18.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An image processing apparatus, comprising:
a depth adjusting unit to determine a second point by moving a first point of a first image constituting stereoscopic images in a viewer centric direction, according to a depth adjustment value, and to determine a third point by projecting the second point onto the first image in a direction from a first viewer's viewpoint associated with the first image to the second point; and
an image synthesizing unit to generate a second image which represents the depth adjusted scene obtained from the first image by determining a color value of the third point.

2. The image processing apparatus of claim 1, wherein a difference between a depth value of the first point and a depth value of the second point is identical to the depth adjustment value.

3. The image processing apparatus of claim 1, wherein
the first point corresponds to a central point of at least one region of the first image, where the at least one region whose depth is set to be adjusted, and
the depth adjusting unit performs depth adjustment for all points included in the at least one region, based on the movement of the first point.

4. The image processing apparatus of claim 1, wherein the depth adjusting unit determines a scaling factor and a translation factor for moving the first point to the third point, based on a position of the first image a position of the first viewer's viewpoint, the viewer centric direction, and the depth adjustment value.

5. An image processing apparatus, comprising:
a plane determining unit to determine a first predetermined plane parallel to a first image constituting stereoscopic images;
a depth adjusting unit to determine a second point by projecting a first point of the first image onto the first plane in a direction of a first viewer's viewpoint associated with the first image, to determine a third point by moving the second point in a viewer centric direction, according to a depth adjustment value, and to determine a fourth point by projecting the third point onto the first image in a direction from the first viewer's viewpoint to the third point; and
an image synthesizing unit to generate a second image which represents the depth adjusted scene obtained from the first image by determining a color value of the fourth point.

6. The image processing apparatus of claim 5, wherein a difference between a depth value of the second point and a depth value of the third point on the first plane is identical to the depth adjustment value.

7. The image processing apparatus of claim 6, wherein the image synthesizing unit determines the color value of the fourth point, based on color values of pixels adjacent to a pixel positioned in the first image at a position corresponding to the fourth point.

8. An image processing apparatus, comprising:
a depth adjusting unit to determine a second point by moving a first point of a first image constituting stereoscopic images according to a depth adjustment value in a normal direction which is perpendicular to the display screen, and to determine a third point by projecting the second point onto the display screen in a direction from a first viewer's viewpoint associated with the first image to the second point; and
an image synthesizing unit to generate a second image which represents the depth adjusted scene obtained from the first image by determining a color value of the third point.

9. An image processing apparatus, comprising:
an object extracting unit to extract an object region from a region of interest (ROI) that is selected from a first image constituting stereoscopic images;
a planar approximation unit to determine a first plane representing a plurality of points, by performing planar approximation with respect to three-dimensional (3D) information about the plurality of points included in the object region; and
a depth adjusting unit to determine a second plane by moving the first plane in a first direction in order to readjust a depth of the object region in the first image.

10. The image processing apparatus of claim 9, wherein the object extracting unit extracts the object region, based on a portion of information from a disparity map associated with the first image, corresponding to the object region of the first image, and color information corresponding to the object region in color information of the first image.

11. The image processing apparatus of claim 9, wherein the object extracting unit removes noise, by performing pre-processing of at least one of erosion and dilation on the object region.

12. The image processing apparatus of claim 9, wherein the planar approximation unit determines the first plane, by applying the least squares method to the 3D information about the plurality of points.

13. The image processing apparatus of claim 9, further comprising:
an image synthesizing unit to generate a second image which represents the depth adjusted scene obtained from the first image, by projecting the object region onto the first image based on the second plane.

14. The image processing apparatus of claim 9, wherein the depth adjusting unit selects a first point in the first plane, determines a direction from the first point to a camera viewpoint associated with the first image to be the first direction, and determines the second plane by moving the first plane in the first direction.

15. The image processing apparatus of claim 14, wherein the depth adjusting unit selects, to be the first point, a point that minimizes loss of color information of the first image, among the plurality of points included in the object region, when the first plane is moved in the first direction.

16. An image processing apparatus, comprising:
an object extracting unit to extract an object region from a first image constituting stereoscopic images; and
a depth adjusting unit to calculate the changed position of the object region, by applying a scaling factor and a translation factor that are determined by changing the depth of the object region in the first image to each of a value of an X and Y coordinates corresponding to a horizontal direction and vertical direction of a plurality of points included in the object region, respectively.

17. The image processing apparatus of claim 16, wherein the depth adjusting unit determines a value by which the object region is moved in at least one direction of the X coordinate direction and the Y coordinate direction such that loss of color information of the first image is minimized, when the depth of the object region in the first image is adjusted by applying the scaling factor.

18. The image processing apparatus of claim 16, further comprising:
an image synthesizing unit to generate a second image which represents the depth adjusted scene obtained from the first image, by reconstructing the object region in the first image using the changed position of the object region.

19. The image processing apparatus of claim 17, wherein the image synthesizing unit compares the second image to the first image, for each pixel, and utilizes pixel values of the first image if a pixel in the first image corresponding to a first pixel included in the second image is included in the object region, in order to determine values of pixels included in the second image.

20. The image processing apparatus of claim 19, wherein the image synthesizing unit determines a value of the first pixel through a bilinear interpolation using pixel values of adjacent pixels, when determining the value of the first pixel included in the second image by the comparison of each pixel fails.

21. An image processing method, comprising:
determining, by a depth adjusting unit of an image processing apparatus, a second point by moving a first point of a first image constituting stereoscopic images in a viewer centric direction, according to a depth adjustment value;
determining, by the depth adjusting unit, a third point by projecting the second point onto the first image in a direction from a first viewer's viewpoint associated with the first image to the second point; and
generating, by an image synthesizing unit of the image processing apparatus, a second image which represents the depth adjusted scene obtained from the first image by determining a color value of the third point.

22. An image processing method, comprising:
determining, by a depth adjusting unit of an image processing apparatus, a scaling factor and a translation factor, based on a position of a first image constituting stereoscopic image, a position of a first viewer's viewpoint corresponding to the first image, a viewer centric direction, and a depth adjustment value;
determining, by the depth adjusting unit, a second point whose depth is adjusted, by applying the scaling factor and the translation factor to position of a first point included in the first image and being a target for depth adjustment; and
generating, by an image synthesizing unit of the image processing apparatus, a second image which represents the depth adjusted scene obtained from the first image by determining a color value of the second point.

23. An image processing method, comprising:
determining, by a plane determining unit of an image processing apparatus, a first predetermined plane parallel to a first image constituting stereoscopic images;
determining a second point by projecting a first point of the first image onto the first plane in a direction of a first viewer's viewpoint associated with the first image, determining a third point by moving the second point in a viewer centric direction, according to a depth adjustment value, and determining a fourth point by projecting the third point onto the first image in a direction from the first viewer's viewpoint to the third point, by a depth adjusting unit of the image processing apparatus; and
generating, by an image synthesizing unit of the image processing apparatus, a second image which represents the depth adjusted scene obtained from the first image by determining a color value of the fourth point.

24. An image processing method, comprising:
extracting, by an object extracting unit of an image processing apparatus, an object region from a region of interest (ROI) that is selected from a first image constituting stereoscopic image;
determining, by a planar approximation unit of the image processing apparatus, a first plane representing a plurality of points, by performing planar approximation with respect to three-dimensional (3D) information about the plurality of points included in the object region; and
determining, by a depth adjusting unit of the image processing apparatus, a second plane by moving the first plane in a first direction in order to readjust a depth of the object region in the first image.

25. The image processing method of claim 24, wherein the extracting comprises extracting the object region, based on a portion of information from a disparity map associated with the first image, corresponding to the object region of the first image, and color information corresponding to the object region in color information of the first image.

26. The image processing method of claim 24, further comprising:
generating, by an image synthesizing unit of the image processing apparatus, a second image which represents the depth adjusted scene obtained from the first image, by projecting the object region onto the first image based on the second plane.

27. An image processing method, comprising:
extracting, by an object extracting unit of an image processing apparatus, an object region from a first image constituting stereoscopic images; and
calculating, by a depth adjusting unit of the image processing apparatus, the changed location values of the object region, by applying a scaling factor and a translation factor that are determined to adjust depth of the object region in the first image to each of a value of an X and Y coordinates corresponding to a horizontal direction and vertical direction of a plurality of points included in the object region, respectively.

28. A non-transitory computer-readable medium comprising a program for instructing a computer to perform the method of claim 21.
